(19) United States
(12) Patent Application Publication
(10) Pub. No.: US 2022/0137393 A1
(43) Pub. Date: May 5, 2022

(54) ELECTROMAGNETIC DRIVEN MICRO MIRROR WITH FLUID OF HIGH REFRACTIVE INDEX AND ITS MANUFACTURING THEREOF

(71) Applicant: Compertum Microsystems Inc., Hsinchu City (TW)

(72) Inventor: Francis Piu Man, Lexington, MA (US)

(21) Appl. No.: 17/090,085

(22) Filed: Nov. 5, 2020

(51) Int. Cl. G02B 26/08

(52) U.S. Cl. CPC G02B 26/085

(57) ABSTRACT

A microelectromechanical systems (MEMS) apparatus, including a package having a cavity formed therein; a semiconductor device disposed within the cavity and including at least one electromagnetically driven MEMS micro-mirror device; a high refractive index fluid disposed within the cavity and at least partially surrounding a portion of the semiconductor device; and a magnet assembly disposed outside the cavity isolating from the fluid. The magnet assembly is magnetically coupled with the micro-mirror device.

### CROSS-REFERENCE TO RELATED PATENT APPLICATION

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates generally to electromagnetic technology, and more particularly to an electromagnetic driven micro-mirror with fluid of high refractive index and its manufacturing thereof.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Microelectromechanical systems (MEMS) micro-mirror or MEMS micro-mirror arrays have many optical applications such as optical switches, optical cross-connection switches and optical mirror scanning.

### SUMMARY

In one aspect, a microelectromechanical systems (MEMS) apparatus is provided, including a package having a cavity formed therein; a semiconductor device disposed within the cavity and including at least one electromagnetically driven MEMS micro-mirror device; a fluid having a refractive index greater than a predetermined index value, ranging from 1.3 to 2, disposed within the cavity and at least partially surrounding a portion of the semiconductor device; and a magnet assembly disposed outside the cavity, wherein the said magnet assembly is isolated from the fluid and is magnetically coupled with the micro-mirror device.

In one embodiment, the micro-mirror device is a one dimensional electromagnetic driven micro-mirror device comprising a substrate; a micro-mirror, having a reflective mirror surface disposed on the micro-mirror; at least one flexure coupled with the micro-mirror and the substrate, allowing the micro-mirror to rotate about the at least one flexure; and at least one coil fixed to the micro-mirror. In one embodiment, the magnetic assembly is configured to generate a magnetic field perpendicular to the at least one flexure, and a current is configured to be applied to the coil. When the magnetic assembly generates the magnetic field and the current is applied to the coil, the micro-mirror and the coil rotate about the flexure in response to the magnetic field. Optionally, in any of the proceeding aspects another implementation of the aspect provides that the micro-mirror device further comprises at least one angle sensor disposed on the flexure. The angle sensor is configured to measure an angle of rotation of the micro-mirror about the at least one flexure, and the at least one angle sensor may be a piezoresistive sensor or a Hall-effect sensor.

In one embodiment, the piezoresistive sensor comprises a plurality of piezoresistive elements coupled in a Wheatstone bridge circuit disposed on the flexure to detect torsional flexing about the axis of the flexure.

Optionally, another implementation of the aspect provides that the MEMS micro-mirror device is in the form of a MEMS micro-mirror array that includes a plurality of MEMS micro-mirrors.

In certain embodiments, the micro-mirror device comprises a substrate; a gimbal; a micro-mirror, having a reflective mirror surface disposed on the micro-mirror; at least one first flexure coupled with the micro-mirror and the gimbal, allowing the micro-mirror to rotate about the at least one first flexure; at least one second flexure coupled with the gimbal and the substrate, allowing the micro-mirror and the gimbal to rotate about the at least one second flexure, wherein the at least one second flexure is substantially orthogonal to the at least one first flexure; at least one first coil fixed to the micro-mirror; and at least one second coil fixed to the gimbal. In one embodiment, the magnetic assembly is configured to generate a first magnetic field perpendicular to the at least one first flexure and a second magnetic field perpendicular to the at least one second flexure, a first current is configured to be applied to the first coil, and a second current is configured to be applied to the second coil. When the magnetic assembly generates the first magnetic field and the first current is applied to the first coil, the micro-mirror and the first coil rotate about the first flexure in response to the first magnetic field. When the magnetic assembly generates the second magnetic field and the second current is applied to the second coil, the micro-mirror, the gimbal and the second coil rotate about the second flexure in response to the second magnetic field. Optionally, in any of the proceeding aspects another implementation of the aspect provides that the micro-mirror device further comprises at least one first angle sensor disposed on the first flexure. The first angle sensor is configured to measure a first angle of rotation of the micro-mirror about the first flexure, and the first angle sensor is a piezoresistive sensor or a Hall-effect sensor. The micro-mirror device further comprises at least one second angle sensor disposed on the second flexure. The second angle sensor measures a second angle of rotation of the micro-mirror about the second flexure, and the second angle sensor is a piezoresistive sensor or a Hall-effect sensor. Optionally, another implementation of the aspect provides that the MEMS micro-mirror device is in the form of a MEMS micro-mirror array that includes a plurality of MEMS micro-mirror.

In certain embodiments, the fluid has a refractive index in a range from 1.3 to 2. In certain embodiments, the fluid is optically transparent to a laser having a wavelength ranging from 700 to 3000 nanometers. In certain embodiments, the fluid is optically transparent to a laser having a wavelength such as 850, 905, 940, 1310, or 1550 nanometers.

In another aspect, the disclosure includes a method of making a MEMS package, comprising providing a package having a cavity formed therein; disposing a semiconductor device within the cavity, wherein the semiconductor device includes at least one electromagnetically driven MEMS micro-mirror device; disposing a fluid within the cavity, wherein the fluid has a refractive index greater than a predetermined index value, ranging from 1.3 to 2, and the fluid at least partially surrounds a portion of the semiconductor device; and disposing a magnet assembly outside the cavity, wherein the magnet assembly is isolated from the fluid and is magnetically coupled with the micro-mirror device.

In one embodiment, the micro-mirror device is a one dimensional electromagnetic driven micro-mirror device comprising a substrate; a micro-mirror, having a reflective mirror surface disposed on the micro-mirror; at least one flexure coupled with the micro-mirror and the substrate, allowing the micro-mirror to rotate about the at least one flexure; and at least one coil fixed to the micro-mirror. In one embodiment, the magnetic assembly is configured to generate a magnetic field perpendicular to the at least one flexure, and a current is configured to be applied to the coil. When the magnetic assembly generates the magnetic field and the current is applied to the coil, the micro-mirror and the coil rotate about the flexure in response to the magnetic field. Optionally, in any of the proceeding aspects another implementation of the aspect provides that the micro-mirror device further comprises at least one angle sensor disposed on the flexure. The angle sensor is configured to measure an angle of rotation of the micro-mirror about the at least one flexure, and the at least one angle sensor may be a piezoresistive sensor or a Hall-effect sensor. Optionally, another implementation of the aspect provides that the MEMS micro-mirror device is in the form of a MEMS micro-mirror array that includes a plurality of MEMS micro-mirrors.

In certain embodiments, the micro-mirror device comprises a substrate; a gimbal; a micro-mirror, having a reflective mirror surface disposed on the micro-mirror; at least one first flexure coupled with the micro-mirror and the gimbal, allowing the micro-mirror to rotate about the at least one first flexure; at least one second flexure coupled with the gimbal and the substrate, allowing the micro-mirror and the gimbal to rotate about the at least one second flexure, wherein the at least one second flexure is substantially orthogonal to the at least one first flexure; at least one first coil fixed to the micro-mirror; and at least one second coil fixed to the gimbal. In one embodiment, the magnetic assembly is configured to generate a first magnetic field perpendicular to the at least one first flexure and a second magnetic field perpendicular to the at least one second flexure, a first current is configured to be applied to the first coil, and a second current is configured to be applied to the second coil. When the magnetic assembly generates the first magnetic field and the first current is applied to the first coil, the micro-mirror and the first coil rotate about the first flexure in response to the first magnetic field. When the magnetic assembly generates the second magnetic field and the second current is applied to the second coil, the micro-mirror, the gimbal and the second coil rotate about the second flexure in response to the second magnetic field.

Optionally, in any of the proceeding aspects, another implementation of the aspect provides that the micro-mirror device further comprises at least one first angle sensor disposed on the first flexure. The first angle sensor is configured to measure a first angle of rotation of the micro-mirror about the first flexure, and the first angle sensor is a piezoresistive sensor or a Hall-effect sensor. The micro-mirror device further comprises at least one second angle sensor disposed on the second flexure. The second angle sensor measures a second angle of rotation of the micro-mirror about the second flexure, and the second angle sensor is a piezoresistive sensor or a Hall-effect sensor. Optionally, another implementation of the aspect provides that the MEMS micro-mirror device is in the form of a MEMS micro-mirror array that includes a plurality of MEMS micro-mirror.

In certain embodiments, the fluid has a refractive index in a range from 1.3 to 2.

In certain embodiments, the fluid is optically transparent to a laser having a wavelength ranging from 700 to 3000 nanometers. In one embodiment, the fluid is optically transparent to a laser having a wavelength of 850, 905, 940, 1310, or 1550 nanometers.

In certain embodiments in any of the proceeding aspects, the fluid has an operating temperature ranging from −40° C. to 150° C. In one embodiment, the operating temperature ranges from −40° C. to 125° C. In one embodiment, the operating temperature ranges from −40° C. to 105° C. In one embodiment, the operating temperature ranges from −40° C. to 85° C.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a schematic illustration of a one-dimensional MEMS micro-mirror in the related art.

FIG. 2 is a schematic illustration of a two-dimensional MEMS micro-mirror in the related art.

FIG. 3A is a perspective schematic illustration of a one-dimensional MEMS apparatus according to one embodiment of the disclosure.

FIG. 3B is a plain schematic illustration of the one-dimensional MEMS apparatus as shown in FIG. 3A.

FIG. 4A is a perspective schematic illustration of a two dimensional MEMS micro-mirror according to another embodiment of the disclosure.

FIG. 4B is a plain schematic illustration of the two-dimensional MEMS apparatus as shown in FIG. 4A.

FIG. 4C shows a two dimensional micro-mirror device coupling with a first piezeoresistive sensor disposed on a first flexure and a second piezoresistive sensor disposed on a second flexure according to one embodiment of the disclosure.

FIG. 5 is a schematic illustration of a two dimensional MEMS micro-mirror with laser and position sensing detector according to another embodiment of the disclosure.

FIG. 6 shows the operation of a two dimensional MEMS micro-mirror with laser and position sensing detector according to another embodiment of the disclosure.

FIG. 7 is a flowchart showing a method of making the MEMS package according to one embodiment of the disclosure.

FIG. 8 is a flowchart showing a method of making the MEMS package according to one embodiment of the disclosure.

FIG. 9 is a schematic illustration of an electro-optical device according to one embodiment of the disclosure.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

The description will be made as to the embodiments of the present invention in conjunction with the accompanying drawings. In accordance with the purposes of this invention, as embodied and broadly described herein, this invention, in one aspect, relates to an injection molding machine device.

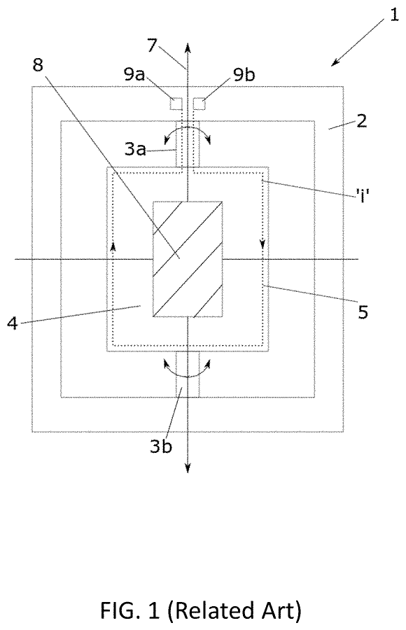

Microelectromechanical systems (MEMS) micro-mirror has many optical applications in optical switch, optical cross connection, and optical mirror scanning. FIG. 1 is an electromagnetic-driven one axis MEMS micro-mirror device 1 in the related art, having a micro-mirror surface 8 disposed on top of a movable micro-mirror 4, where the micro-mirror is supported to the substrate 2 by two flexures 3a, 3b. The two flexures 3a and 3b are coaxially aligned along a flexure axis 7. A coil 5 is disposed on the micro-mirror. When a current ‘i’ is applied to the coil through pads 9a and 9b under the influence of an external magnetic field (not shown), the micro-mirror rotates about the flexure axis 7 along the length of the flexure. In air (refractive index=1), a one axis MEMS mirror can rotate a flexure with an optical angle θ_{optical} that is equivalent to an optical angle θ_{optical}=2θmech.

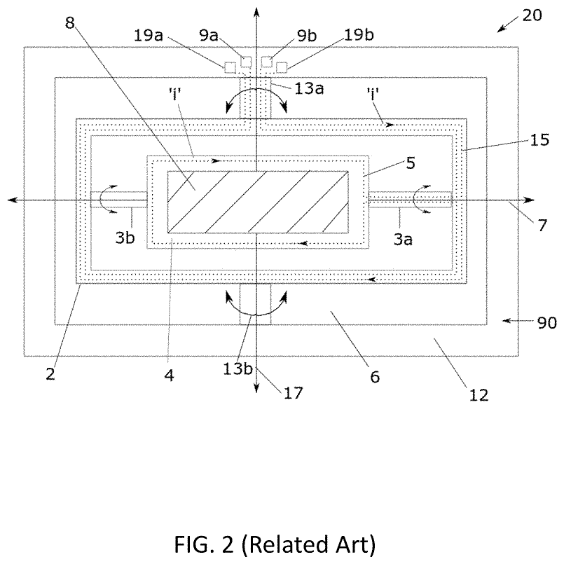

FIG. 2 is an electromagnetic-driven two axis MEMS micro-mirror device 20 in the related art, having a micro-mirror surface 8 disposed on top of a movable micro-mirror 4, where the micro-mirror is supported to the gimbal 2 by two flexures 3a, 3b suspended in a cavity 6. The two flexures 3a and 3b are coaxially aligned along a flexure axis 7. The gimbal 15 is in turn supported by two flexures 13a, 13b to a substrate 90. The two flexures 13a and 13b are coaxially aligned along another flexure axis 17. A first coil 5 is disposed on the micro-mirror. When a current ‘i’ is applied to the first coil 5 through pads 9a and 9b under the influence of an external magnetic field (not shown), the micro-mirror pivots about the flexure axis 7. A second coil 15 is disposed on the gimbal 2. When a current ‘i’ is applied to the second coil 15 through pads 19a and 19b under the influence of an external magnetic field (not shown), the micro-mirror pivots about the flexure axis 17.

A desirable feature of such MEMS mirror is a large scanning angle. An example of a MEMS mirror array is described by J. J. Bernstein, et al., Journal of Microelectromechanical Systems, Vol. 13, No. 3, June 2004, p. 526-535, “Electro-magnetically actuated mirror arrays for use in 3-D optical switching applications.” Typically MEMS devices can rotate about +−7.5 mechanical degree which is equivalent to +−15 optical degree. However, many optical applications call for larger scanning angle. Another issue related to MEMS mirror is its reliability. Even when a MEMS device scans continuously within +−7.5 mechanical degree, its flexure may fatigue causing reliability issue. Large scanning angle might reduce mirror reliability.

One aspect of this invention herein discloses a MEMS apparatus, which includes a MEMS micro-mirror device that is immersed in a fluid with high refractive index to achieve larger rotation angle. When light travels exits from medium with higher refractive index n to air, according to Snell's Law

sin(θ_{optical})=n*sin(2*θ_{mech})

Assuming θ˜sin(θ), θ_{optical}˜2*n*θ_{mech}, thus optical angle has been magnified by n, where n could ranges from 1.3 to 2. Therefore, when the micro-mirror rotates with +−7.5 mechanical degree in a fluid with refractive index of 2, it rotates about +−30 optical degree. Such optical angle magnification should meet the requirement of large scanning angle. In addition, to mitigate reliability issue, the micro-mirror could rotate with a reduced mechanical angle (+−7.5/2°=)+−3.75° such that its optical angle still remains +−15 optical degree. Continuous rotation of a reduced mechanical angle helps reliability.

When a micro-mirror is driven electromagnetically, current passes through a coil causing the micro-mirror to scan. However, large scan angle requires large current and power consumption causing local fluid temperature increase. When the external magnet is exposed to such fluid with high temperature, its temperature increases causing its magnetic field to degrade.

Table 1 shows a list of magnets with various grades, its magnetic strength and its maximum operating temperature. It can be seen that magnets with higher magnetic strength operate at lower temperature. Therefore, it is imperative that the magnetic assembly be thermally isolated from the heated fluids without degrading the magnetic strength of the magnet. Otherwise, as magnetic strength decays, scan angle reduces.

TABLE 1

| Grade | Remanence (mT) | Max. working temperature |
|---|---|---|
| N55 | 14.6-15.2 | ≤60 C. |
| N52 | 14.4-14.8 | ≤60 C. |
| N50 | 14.0-14.5 | ≤80 C. |
| N50M | 14.0-14.5 | ≤100 C. |
| N48H | 13.7-14.3 | ≤120 C. |

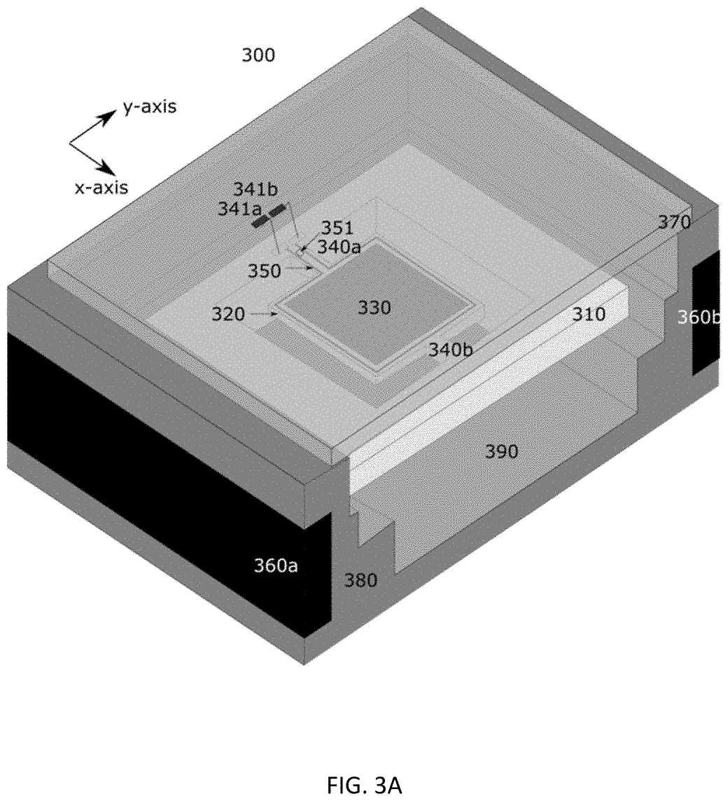

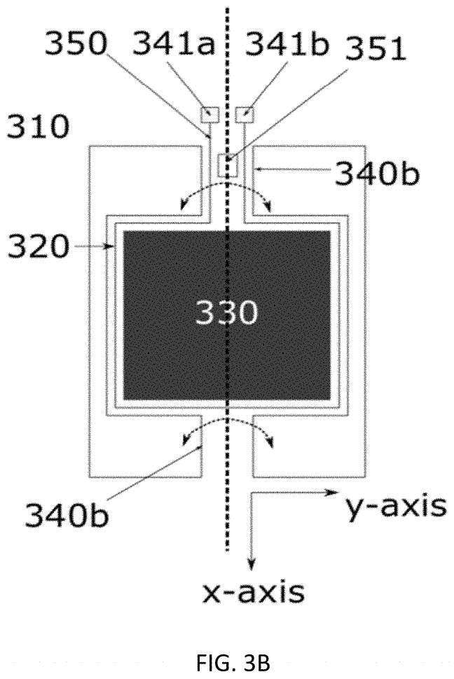

FIGS. 3A and 3B schematically show a MEMS apparatus 300 according to one embodiment of the disclosure. The MEMS apparatus 300 is in the form of a package, which has a cavity 390 formed therein. A MEMS micro-mirror device is disposed within the cavity 390. A high refractive index fluid is disposed within the cavity 390, where the refractive index of the fluid is greater than a predetermined index value ranging from 1.3 to 2. A magnet assembly, which is formed by a plurality of individual magnets 360a, 360b, is disposed outside the cavity 390 and isolated from the fluid.

As shown in FIG. 3A, the MEMS micro-mirror device includes a substrate 310, a micro-mirror 320 having a reflective micro-mirror surface 330 disposed thereon, two flexures 340a, 340b along the X-axis, and at least a coil 350 fixed to the micro-mirror 320. The micro-mirror 320 is suspended by the two flexures 340a, 340b to the substrate 310. Such micro-mirror 320 is driven by an electromagnetic mechanism, which is formed by the at least one coil 350 disposed on the micro-mirror device. A current is passed through the at least one coil 350 causing the micro-mirror 320 to rotate about the flexures 340a, 340b along the X-axis under the influence of an external magnetic field substantially orthogonal (along the Y-axis) to the two flexures 340a, 340b, where the external magnetic field is generated by the magnetic assembly formed by the individual magnets 360a, 360b disposed in the vicinity of the mirror device. The coil 350 is connected externally through pads (341a, 341b).

The micro-mirror device is exposed at least partially to a high refractive index fluid disposed within the cavity. The fluid may be but not limited to liquid such as cooking corn oil, automotive oils (brake fluid, hydraulic engine oil, microscope immersion oils, glycerin, alcohols, alkanes, silicone oils, chlorofluorocarbon, perfluorocarbon, siloxane, aliphatic hydrocarbons, alicyclic hydrocarbons, hydrogenated terphenyl, 1-bromonaphthalene, 1-lodonaphthalene, sulfur, diiodomethane, tin iodide, triacetin, ethyl cinnamate, chlorofluorocarbon, and polyphenyl ether based optical fluids. The refractive index could range from 1.3 to 2.

In certain embodiments, the fluid has an operating temperature ranging from −40° C. to 150° C. In one embodiment, the operating temperature ranges from −40° C. to 125° C. In one embodiment, the operating temperature ranges from −40° C. to 105° C. In one embodiment, the operating temperature ranges from −40° C. to 85° C.

The magnet assembly (360a, 360b) is disposed outside the cavity 390 such that it is isolated by an isolation material 380 from the fluid. As explained above, the magnet assembly (360a, 360b) is not exposed to the fluid because the fluid is heated due to the current applied to the coil and the heated fluid would degrade its magnetic field when exposed to high temperature.

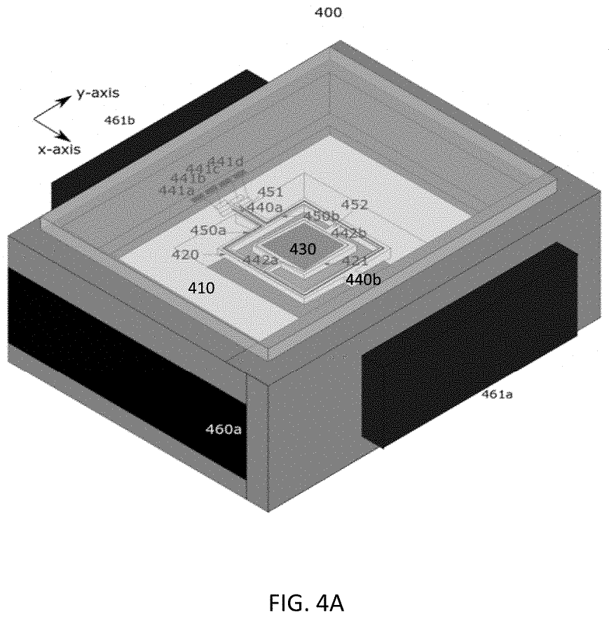

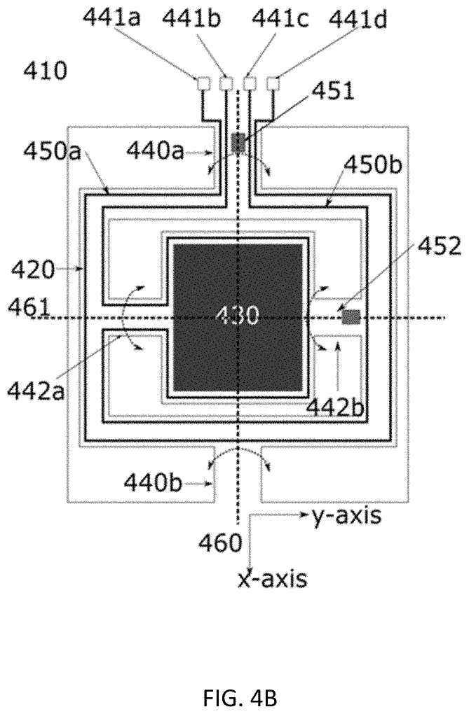

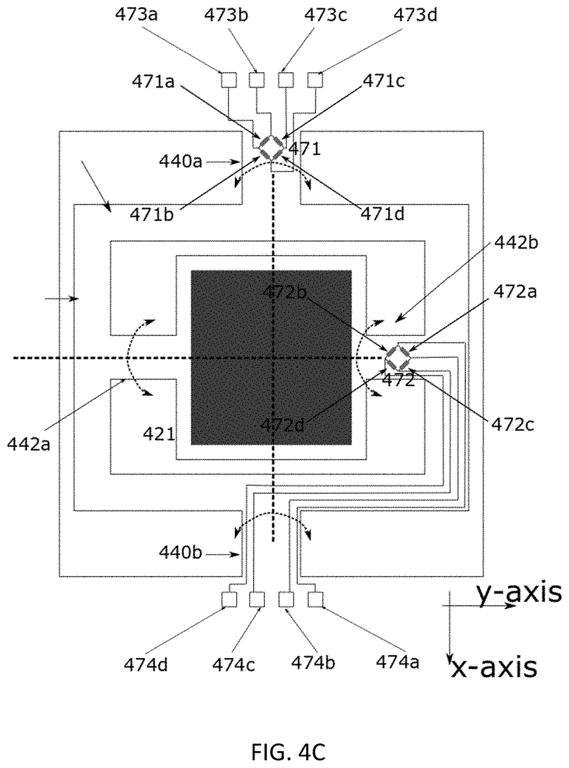

FIGS. 4A and 4B schematically show a MEMS apparatus 400 according to one embodiment of the disclosure. The MEMS apparatus 400 is in the form of a package, which has a cavity 490 formed therein. A microelectromechanical (MEMS) micro-mirror device is disposed within the cavity 490. A high refractive index fluid is disposed within the cavity 490. A magnet assembly, which is formed by a plurality of individual magnets 460a, 460b, 461a, 461b, is disposed outside the cavity 490 and isolated from the fluid.

As shown in FIG. 4A, the micro-mirror device includes a substrate 410; a gimbal 420; a micro-mirror 421; a reflective mirror surface 430 disposed on the micro-mirror 421, two first flexures (442a, 442b) coupled with the micro-mirror 421 and the gimbal 420; two second flexures (440a, 440b) coupled with the gimbal 420 and the substrate 410; at least one first coil 450a fixed to the micro-mirror 421; and at least one second coil 450b fixed to the gimbal 420. When the magnetic assembly (461a, 461b) generates a first magnetic field and a first current is applied to the first coil 450a, the micro-mirror 421 and the first coil 450a rotate about the first flexures (442a, 442b) in response to the first magnetic field. When the magnetic assembly (460a, 460b) generates a second magnetic field and a second current is applied to the second coil 450b, the micro-mirror 421, the gimbal 420 and the second coil 450b rotate about the second flexures (440a, 440b) in response to the second magnetic field.

In certain embodiments, the micro-mirror device further comprises at least one first angle sensor disposed on the first flexures (442a, 442b) and another at least one second angle sensor disposed on the second flexures (440a, 440b). The first angle sensor is configured to measure the torsional stress of the first flexure as the micro-mirror 421 rotates thus corresponding to a first angle of rotation of the micro-mirror about the first flexures (442a, 442b). Similarly the second angle sensor is configured to measure the torsional stress of the second flexure as the micro-mirror 421 rotates thus corresponding to a second angle of rotation of the micro-mirror 421 about the second flexures (440a, 440b). Each of the first angle sensor and the second angle sensor may be formed by a piezoresistivesensor or a Hall-effect sensor.

In certain embodiment, the piezoresistive sensor may be formed by a plurality of piezoresistive elements coupled in a Wheatstone bridge circuit disposed on the flexure to detect torsional flexing about the axis of the flexure. FIG. 4C shows a two dimensional micro-mirror device coupling with a first piezeoresistive sensor (471) disposed on a first flexure 440a and a second piezoresistive sensor (472) disposed on a second flexure 442b according to one embodiment of the disclosure. As shown in FIG. 4C, the first piezoresistive sensor (471) comprises a plurality of piezoresistive elements (471a, 471b, 471c, 471d) in a Wheatstone bridge circuit, where all four elements have substantially identical resistance. Similarly, the second piezoresistive sensor (472) comprises a plurality of piezoresistive elements (472a, 472b, 472c, 472d) in a Wheatstone bridge circuit where all four elements have substantially identical resistance. A voltage is biased to the Wheatstone bridge between 473b and 473d, and a differential potential is measured between 473a, and 473c. When the micro-mirror does not rotate, no differential potential measured. As the micro-mirror (421) rotates along first flexure (440a), the first flexure experiences change in torsional stress and the resistance of piezoresistive elements changes such that resistance of the piezoresistive elements 471a and 471d change while resistance of the piezoresistive elements 471b and 471c change in an opposite direction. As a result, a differential potential is measured corresponding to angle of rotation along first flexure. Similarly, a second piezoresistive sensor (472) is disposed on the second flexure 442b comprising a plurality of piezoresistive elements (472a, 472b, 472c, 472d) in a Wheatstone bridge circuit where all four elements have substantially identical resistance. When a voltage is biased between 474b and 474d, no potential difference is measured between 474a and 474c. When the micro-mirror 421 rotates along second flexure (442b), the second flexure experiences a change in torsional stress causing differential potential between 474b and 474d which corresponds to angle of rotation along second flexure 442b. Additional piezoresistive sensors could also be disposed on flexure 440b and 442a to improve angle sensitivity.

In certain embodiments, angle sensors could also be displaced external to MEMS chip.

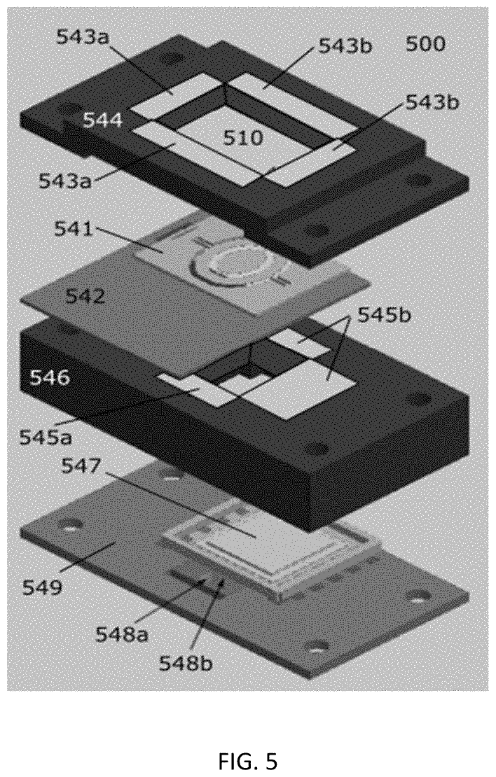

FIG. 5 shows a MEMS apparatus 500, which comprises a MEMS microdevice (541) sitting on a substrate (542), a plurality of magnets (543a, 543b, 545a, 545b) sitting on fixture (544, 546), and an on-package angle sensor on a printed circuit board (549) including a light source 548a that could be a light emitting diode (LED), laser source or Vertical-Cavity Surface-Emitting Laser (VCSEL); and a fixture 548b and optical angle sensor 547. Magnets 543a, 543b, 545a, and 545b are configured to form a magnetic field leaving a cavity 510 for the micro-mirror to rotate. The fixture 548b defines the tilting angle of the light source such that the light source points to the backside surface of MEMS mirror.

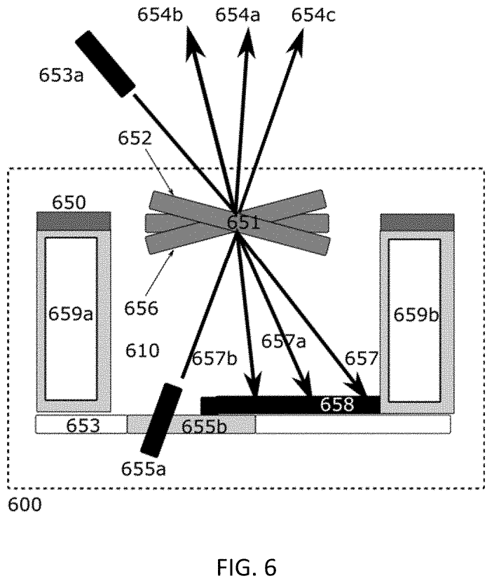

FIG. 6 shows the operation of the on-package optical angle sensor, wherein the light source 655a emits a light that reflects off the micro-mirror surface 656 on the back side of the micro-mirror device 651 and reaches the optical angle sensor 658 such that the optical angle sensor 658 measures the rotating angle of the micro-mirror device 651 about the first flexure and second flexure (not shown in FIG. 6). Specifically, the optical angle sensor 658 the position of the light hitting the sensor surface (657, 657a, 657b) which corresponds to the angle of light reflection, and thus the rotating angle of the micro-mirror surface 656 about the first flexure and second flexure may be obtained correspondingly. In certain embodiments, the optical angle sensor could be a Position Sensitive Detector (PSD) or a Charge Coupled Device (CCD).

The MEMS micro-mirror device is in the form of a MEMS micro-mirror array that includes a plurality of MEMS micro-mirror. The fluid has a refractive index in a range from 1.3 to 2. The fluid is optically transparent to a laser having near infra-red wavelength 700 to 3000 nanometers in particular 850, 905, 940, 1310, or 1550 nanometers.

The magnet assembly (460a, 460b, 461a, 461b) is disposed outside the cavity such that it is isolated by an isolation material 480 from the fluid. As explained above, the magnet assembly is not exposed to the fluid because the fluid is heated due to the current applied to the coil and the heated fluid would degrade its magnetic field when exposed to high temperature.

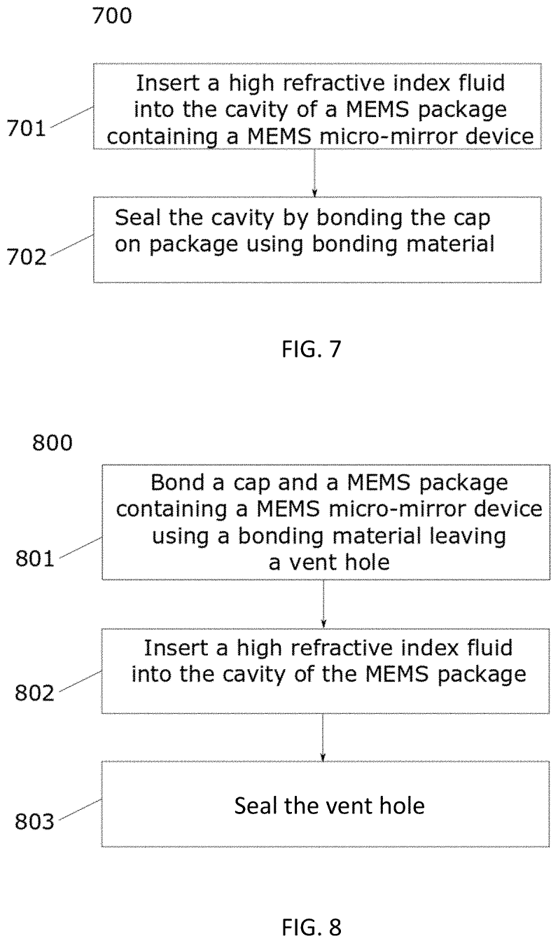

FIG. 7 is a flowchart showing a method of making a MEMS package of FIG. 3-4. In block 701, the high refractive index fluid is disposed in the cavity of the package containing the MEMS micro-mirror. In block 702, the cavity is sealed by bonding the cap on the package using a bonding material.

FIG. 8 shows another embodiment where a cap is placed and bonded on MEMS package using bonding material leaving at least one vent hole (Block 801). High refractive index fluid is inserted into the cavity (Block 802), followed by sealing the vent hole(s)(Block 803).

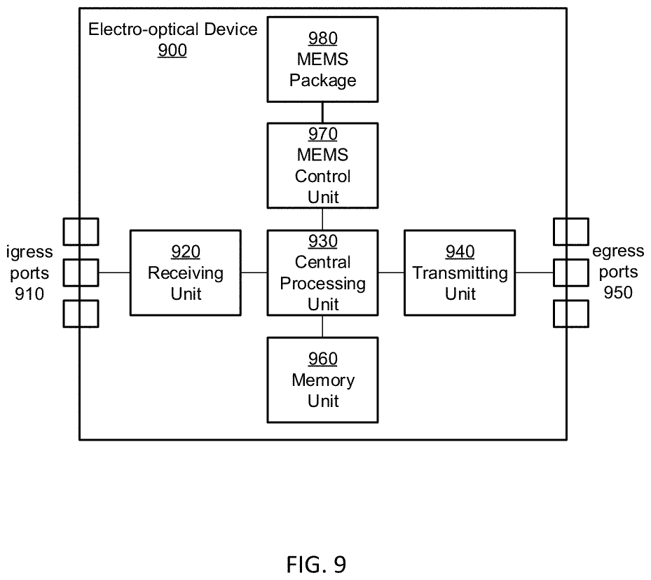

FIG. 9 is a schematic diagram of an electro-optical device according to one embodiment of the disclosure. The electro-optical device 900 comprises ingress ports 910 and at least one receiving unit (Rx) 920, a central processing unit 930; at least one transmitting unit (Tx) 940, egress ports 950, a memory unit 960, a MEMS control unit 970, and a MEMS package 980.

The central processing unit 930 processes data implementing by one or more computer chip(s) such as field programmable gate arrays (FPGAs), application specific integrated circuits (ASICs), digital signal processors (DSPs). The processing unit 930 inputs data or control signals from the igress ports 910 through the receiving ports 920. The processing unit 930 also stores and retrieves data, or program to and from memory unit 960. The memory unit can be in form of tape drives, solid state drives, or flash memory. The memory unit could be volatile, non-volatile, read-only memory (ROM), random access memory (RAM), ternary content-addressable memory (TCAM), static random-access memory (SRAM) and combination thereof. The unit also exports data to egress ports 950 through transmitting unit 940. It communicates with the MEMS control unit 970 which in turns controls the MEMS package.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

### REFERENCE LIST

[1]. U.S. Patent Application No. 2019/0049717A1
[2]. U.S. Pat. No. 9,405,116
[3]. J. J. Bernstein, et al., Journal of Microelectromechanical Systems, Vol. 13, No. 3, June 2004, p. 526-535, “Electro-magnetically actuated mirror arrays for use in 3-D optical switching applications.”, DOI: 10.1109/JMEMS.2004.828705

What is claimed is:

1. A microelectromechanical systems (MEMS) apparatus, comprising:
a package having a cavity formed therein;
a semiconductor device disposed within the cavity and including at least one electromagnetically driven MEMS micro-mirror device;
a fluid having a refractive index greater than a predetermined index value, disposed within the cavity and at least partially surrounding a portion of the semiconductor device; and
a magnet assembly disposed outside the cavity, wherein the magnet assembly is isolated from the fluid and is magnetically coupled with the micro-mirror device.

2. The MEMS apparatus of claim 1, wherein the magnet assembly comprises a plurality of individual magnets.

3. The MEMS apparatus of claim 1, wherein the predetermined index value of the fluid ranges from 1.3 to 2.

4. The MEMS apparatus of claim 1, wherein the fluid has an operating temperature ranging from −40° C. to 125° C.

5. The MEMS apparatus of claim 1, wherein the fluid has an operating temperature ranging from −40° C. to 105° C.

6. The MEMS apparatus of claim 1, wherein the fluid has an operating temperature ranging from −40° C. to 85° C.

7. The MEMS apparatus of claim 1, wherein the fluid is optically transparent to a laser having a wavelength ranging from 700 to 3000 nanometers.

8. The MEMS apparatus of claim 1, wherein the fluid is optically transparent to a laser having a wavelength of 850, 905, 940, 1310, or 1550 nanometers.

9. The MEMS apparatus of claim 1, wherein the fluid is a liquid selected from a group consisting of cooking corn oil, automotive oils (brake fluid, hydraulic engine oil), microscope immersion oils, glycerin, alcohols, alkanes, silicone oils, perfluorocarbon, siloxane, aliphatic hydrocarbons, alicyclic hydrocarbons, hydrogenated terphenyl, 1-bromonaphthalene, 1-lodonaphthalene, sulfur, diiodomethane, tin iodide, triacetin, ethyl cinnamate, chlorofluorocarbon, and polyphenyl ether based optical fluids.

10. The MEMS apparatus of claim 1, wherein the micro-mirror device comprises:
a substrate;
a micro-mirror, having a reflective mirror surface disposed on the micro-mirror;
at least one flexure coupled with the micro-mirror and the substrate, allowing the micro-mirror to rotate about the at least one flexure; and
at least one coil fixed to the micro-mirror,
wherein the magnetic assembly is configured to generate a magnetic field perpendicular to the at least one flexure, and a current is configured to be applied to the coil;
wherein when the magnetic assembly generates the magnetic field and the current is applied to the coil, the micro-mirror and the coil rotate about the flexure in response to the magnetic field.

11. The MEMS apparatus of claim 10, wherein the micro-mirror device further comprises at least one angle sensor disposed on the flexure, the angle sensor is configured to measure the change in torsional stress of the at least one flexure as the micro-mirror rotates thus corresponding to an angle of rotation of the micro-mirror about the at least one flexure, and the at least one angle sensor is a piezoresistive sensor or a Hall-effect sensor.

12. The MEMS apparatus of claim 10, further comprising:
a light source selected from a group consisting of a light emitting diode (LED), a laser source, and a Vertical-Cavity Surface-Emitting Laser (VCSEL), wherein the light source is configured to emit a light toward the micro-mirror device, and the light emitted by the light source is reflected by a back side of the micro-mirror device; and
an optical angle sensor, being a Position Sensitive Detector (PSD) or a Charge Coupled Device (CCD), wherein the optical angle sensor is located such that the light reflected by a back side of the micro-mirror device is configured to reach the optical angle sensor, and the angle sensor is configured to measure a rotating angle of the reflective mirror surface about the flexure.

13. The MEMS apparatus of claim 1, wherein the micro-mirror device comprises:
a substrate;
a gimbal;
a micro-mirror, having a reflective mirror surface disposed on the micro-mirror;
at least one first flexure coupled with the micro-mirror and the gimbal, allowing the micro-mirror to rotate about the at least one first flexure;
at least one second flexure coupled with the gimbal and the substrate, allowing the micro-mirror and the gimbal to rotate about the at least one second flexure, wherein the at least one second flexure is substantially orthogonal to the at least one first flexure;
at least one first coil fixed to the micro-mirror; and
at least one second coil fixed to the gimbal,
wherein the magnetic assembly is configured to generate a first magnetic field perpendicular to the at least one first flexure and a second magnetic field perpendicular to the at least one second flexure, a first current is configured to be applied to the first coil, and a second current is configured to be applied to the second coil;
wherein when the magnetic assembly generates the first magnetic field and the first current is applied to the first coil, the micro-mirror and the first coil rotate about the first flexure in response to the first magnetic field; and
wherein when the magnetic assembly generates the second magnetic field and the second current is applied to the second coil, the micro-mirror, the gimbal and the second coil rotate about the second flexure in response to the second magnetic field.

14. The MEMS apparatus of claim 13, wherein the micro-mirror device further comprises at least one first angle sensor disposed on the first flexure, the first angle sensor is configured to measure the change of the torsional stress of the first flexure as the micro-mirror rotates thus corresponding to a first angle of rotation of the micro-mirror about the first flexure, and the first angle sensor is a piezoresistive sensor or a Hall-effect sensor.

15. The MEMS apparatus of claim 14, wherein the micro-mirror device further comprises at least one second angle sensor disposed on the second flexure, the second angle sensor measures the change in the torsional stress of the second flexure as the micro-mirror rotates thus corresponding to a second angle of rotation of the micro-mirror about the second flexure, and the second angle sensor is a piezoresistive sensor or a Hall-effect sensor.

16. A method of making a microelectromechanical systems (MEMS) apparatus, comprising:
providing a package having a cavity formed therein;
disposing a semiconductor device within the cavity, wherein the semiconductor device includes at least one electromagnetically driven MEMS micro-mirror device;
disposing a fluid within the cavity, wherein the fluid has a refractive index greater than a predetermined index value, and the fluid at least partially surrounds a portion of the semiconductor device; and
disposing a magnet assembly outside the cavity, wherein the magnet assembly is isolated from the fluid and is magnetically coupled with the micro-mirror device.

17. The method of claim 16, wherein the magnet assembly comprises a plurality of individual magnets.

18. The method of claim 16, wherein the predetermined index value of the fluid is in a range from 1.3 to 2.

19. The method of claim 16, wherein the fluid has an operating temperature ranging from −40° C. to 150° C.

20. The method of claim 19, wherein the operating temperature ranges from −40° C. to 125° C.

21. The method of claim 19, wherein the operating temperature ranges from −40° C. to 105° C.

22. The method of claim 19, wherein the operating temperature ranges from −40° C. to 85° C.

23. The method of claim 16, wherein the fluid is optically transparent to a laser having a wavelength ranging from 700 to 3000 nanometers.

24. The method of claim 16, wherein the fluid is optical transparent to a laser having a wavelength of 850, 905, 940, 1310, or 1550 nanometers.

25. The method of claim 16, wherein the fluid is a liquid selected from a group consisting of cooking corn oil, automotive oils (brake fluid, hydraulic engine oil), microscope immersion oils, glycerin, alcohols, alkanes, silicone oils, perfluorocarbon, siloxane, aliphatic hydrocarbons, alicyclic hydrocarbons, hydrogenated terphenyl, 1-bromonaphthalene, 1-lodonaphthalene, sulfur, diiodomethane, tin iodide, triacetin, ethyl cinnamate, chlorofluorocarbon, and polyphenyl ether based optical fluids.

26. The method of claim 16, wherein the micro-mirror device comprises:
a substrate;
a micro-mirror, having a reflective mirror surface disposed on the micro-mirror;
at least one flexure coupled with the micro-mirror and the substrate, allowing the micro-mirror to rotate about the at least one flexure; and
at least one coil fixed to the micro-mirror,
wherein the magnetic assembly is configured to generate a magnetic field perpendicular to the at least one flexure, and a current is configured to be applied to the coil;
wherein when the magnetic assembly generates the magnetic field and the current is applied to the coil, the micro-mirror and the coil rotate about the flexure in response to the magnetic field.

27. The method of claim 26, wherein the micro-mirror device further comprises at least one angle sensor disposed on the flexure, the angle sensor is configured to measure an angle of rotation of the micro-mirror about the at least one flexure, and the at least one angle sensor is a piezoresistive sensor or a Hall-effect sensor.

28. The method of claim 16, wherein the micro-mirror device comprises:
a substrate;
a gimbal;
a micro-mirror, having a reflective mirror surface disposed on the micro-mirror;
at least one first flexure coupled with the micro-mirror and the gimbal, allowing the micro-mirror to rotate about the at least one first flexure;
at least one second flexure coupled with the gimbal and the substrate, allowing the micro-mirror and the gimbal to rotate about the at least one second flexure, wherein the at least one second flexure is substantially orthogonal to the at least one first flexure;
at least one first coil fixed to the micro-mirror; and
at least one second coil fixed to the gimbal,
wherein the magnetic assembly is configured to generate a first magnetic field perpendicular to the at least one first flexure and a second magnetic field perpendicular to the at least one second flexure, a first current is configured to be applied to the first coil, and a second current is configured to be applied to the second coil;
wherein when the magnetic assembly generates the first magnetic field and the first current is applied to the first coil, the micro-mirror and the first coil rotate about the first flexure in response to the first magnetic file; and
wherein when the magnetic assembly generates the second magnetic field and the second current is applied to the second coil, the micro-mirror, the gimbal and the second coil rotate about the second flexure in response to the second magnetic field.

29. The method of claim 28, wherein the micro-mirror device further comprises at least one first angle sensor disposed on the first flexure, the first angle sensor is configured to measure a first angle of rotation of the micro-mirror about the first flexure, and the first angle sensor is a piezoresistive sensor or a Hall-effect sensor.

30. The method of claim 29, wherein the micro-mirror device further comprises at least one second angle sensor disposed on the second flexure, the second angle sensor is configured to measure a second angle of rotation of the micro-mirror about the second flexure, and the at least one second angle sensor is a piezoresistive sensor or a Hall-effect sensor.
